(19) United States
(12) Patent Application Publication
(10) Pub. No.: US 2013/0176998 A1
(43) Pub. Date: Jul. 11, 2013

(54) Mechanism For Coexistence Between Wireless Networks

(71) Applicants: Sayantan Choudhury, Berkeley, CA (US); Klaus F. Doppler, Albany, CA (US); Chittabrata Ghosh, Union City, CA (US)

(72) Inventors: Sayantan Choudhury, Berkeley, CA (US); Klaus F. Doppler, Albany, CA (US); Chittabrata Ghosh, Union City, CA (US)

(73) Assignee: Nokia Corporation

(21) Appl. No.: 13/345,019

(22) Filed: Jan. 6, 2012

(51) Int. Cl. H04W 84/12

(52) U.S. Cl. 370/338

(57) ABSTRACT

In accordance with the exemplary embodiments there is at least a method performed with an apparatus of a wireless communication network including sensing information regarding at least one coexisting network, and sending the information in a header of a media access control frame to a network node of the wireless communication network. In addition, in accordance with the embodiments, there is at least a method performed with an apparatus of a wireless communication network including receiving sensing information regarding at least one coexisting network in a header of a media access control frame from at least one device of the wireless communication network, determining, using at least the sensing information, occupancy information regarding one or more coexisting networks of the wireless communication network, and sending the occupancy information to one or more devices of the wireless communication network.

### TECHNICAL FIELD

The exemplary embodiments of this invention relate generally to a method to manage interference between coexisting networks such as between wireless networks, and more specifically relate to a method to exchange in information between network devices regarding a coexisting network.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Certain abbreviations that may be found in the description and/or in the Figures are herewith defined as follows:

ACK acknowledgement

AP access point

AUC authentication center

CAP contention access period

CFP contention free period

CP cyclic prefix

CRC cyclic redundancy check

CTS clear to send

CX coexisting network exchange

DCF distributed coordination function

DFT discrete Fourier transform

DL downlink

EDCA enhanced distributed channel access

FFT fast fourier transform

GI guard interval

MAC media access control

MCC mobile country code

MCN mobile network code

ML maximum likelihood

MNO mobile network operator

MU macro urban

OFDM orthogonal frequency domain multiplex

PCF point coordination function

PP-MAC probe and pull media access control

PSMP power save multi-poll

PHY ACK physical layer acknowledgement

PLCP physical layer convergence protocol

QoS quality of service

RIFS reduced interframe space

RTS request to send

SCM spatial channel module

SIFS short inter-frame space

SNR signal to noise ratio

SPI stateful packet inspection

STA station

TSPEC traffic specification

UL uplink

VLR visitor location register

VNO visitor network operator

WLAN wireless local area network

### SUMMARY

In an exemplary aspect of the invention, there is a method comprising sensing, by a device of a wireless communication network, information regarding at least one coexisting network, and sending the information in a header of a media access control frame to a network node of the wireless communication network.

In an exemplary aspect of the invention, there is an apparatus, comprising at least one processor, and at least one memory including computer program code, where the at least one memory and the computer program code are configured, with the at least one processor, to cause the apparatus to at least sense, with a device of a wireless communication network, information regarding at least one coexisting network, and send the information in a header of a media access control frame to a network node of the wireless communication network.

In an exemplary aspect of the invention, there is an apparatus, comprising means for sensing, with a device of a wireless communication network, information regarding at least one coexisting network, and means for sending the information in a header of a media access control frame to a network node of the wireless communication network.

In another exemplary aspect of the invention, there is a method comprising receiving, by a network node in a wireless communication network, sensing information regarding at least one coexisting network in a header of a media access control frame from at least one device of the wireless communication network, determining, using at least the sensing information, occupancy information regarding one or more coexisting networks of the wireless communication network, and sending the occupancy information to one or more devices of the wireless communication network.

In still another exemplary aspect of the invention, there is an apparatus, comprising at least one processor, and at least one memory including computer program code, where the at least one memory and the computer program code are configured, with the at least one processor, to cause the apparatus to at least receive, with a network node in a wireless communication network, sensing information regarding at least one coexisting network in a header of a media access control frame from at least one device of the wireless communication network, determine, using at least the sensing information, occupancy information regarding one or more coexisting networks of the wireless communication network, and send the occupancy information to one or more devices of the wireless communication network.

In yet another exemplary aspect of the invention, there is apparatus, comprising means for receiving, with a network node in a wireless communication network, sensing information regarding at least one coexisting network in a header of a media access control frame from at least one device of the wireless communication network, means for determining, using at least the sensing information, occupancy information regarding one or more coexisting networks of the wireless communication network, and means for sending the occupancy information to one or more devices of the wireless communication network.

### BRIEF DESCRIPTION OF THE DRAWINGS

FIG. 1 illustrates the probe and pull media access control operation;

FIG. 2A illustrates an Uplink and Downlink Mechanism for a PP-MAC;

FIG. 2B is a simplified block diagram of various devices which are exemplary electronic devices suitable for use in practicing the exemplary embodiments of the invention;

FIG. 3A illustrates a type of known or generic type of 802.11 Packet Structure which can be used to practice the exemplary embodiments of the invention;

FIG. 3B illustrates a CX-PP-MAC Allocation frame format for a Network Node or access point, as in accordance with the exemplary embodiments of the invention;

FIG. 3C illustrates a PLCP header for the CX-PP-MAC to support coexistence based on sensing, as in accordance with the exemplary embodiments of the invention;

FIG. 3D illustrates a MAC frame format with modified MAC header for the CX-PP-MAC, as in accordance with the exemplary embodiments of the invention; and

FIGS. 4 and 5 are logic flow diagrams that each illustrates the operation of a method, and a result of execution of computer program instructions embodied on a computer readable memory, in accordance with the exemplary embodiments of this invention.

### DETAILED DESCRIPTION

The exemplary embodiments of the invention provide a method manage interference between coexisting networks as well as enabling the exchange of information between network devices regarding a coexisting network in a MAC layer implementation. Different wireless networks may coexist in the same geographical area. These networks may operate simultaneously on at least a partially overlapping frequency spectrum. Thus, the operations of such networks can cause interference to each other. To avoid and/or control this interference, the exemplary embodiments provide at least sub-carrier nulling mechanisms using coexistence reporting between network devices.

IEEE 802.11 standards are defined for implementing wireless local area network (WLAN) communications. The 802.11 standards were and will be created by the IEEE LAN/MAN Standards Committee (IEEE 802). IEEE 802.11 identifies a series of over-the-air modulation techniques that use a similar basic protocol. Wi-Fi is a brand name for products using the IEEE 802.11 family of standards. The exemplary embodiments of the invention can be used to provide a benefit for at least communications as defined by known 802.11 standards, as well as for the PP-MAC allocation frame, such as described in application Ser. No. 13/289,332.

It is noted that any reference to PP-MAC Frame in this description is non-limiting and the exemplary embodiments of the invention can be practiced to the advantage of wireless communications using any generic media access control frame. Similarly, any Figures which illustrate PP-MAC operations and/or packet structures are non-limiting. For example, the exemplary embodiments of the invention can be practiced with any generic wireless communication signaling related to a point coordination function (PCF), a power save multi-poll (PSMP), and a distributed coordination function (DFC), to name only a few.

An access point (AP) is a device that allows wireless devices to connect to a wired network using Wi-Fi or 802.11 standards. The AP usually connects to a router (via a wired network), and can relay data between the wireless devices (such as computers or printers) and wired devices of the network.

The 802.11 standard specifies a common media access control (MAC) Layer, which provides a variety of functions that support the operation of 802.11-based WLANs. In general, the MAC Layer manages and maintains communications between 802.11 stations, mobile electronic devices and/or access points by coordinating the access with a shared radio channel and utilizing protocols that allow communications over the WLAN.

The exemplary embodiments of the invention provide at least an extension of the PP-MAC allocation frame, such as described in application Ser. No. 13/289,332. For this reason some operations of the PP-MAC allocation frame, as described in application Ser. No. 13/289,332, are similarly described below with regards to the exemplary embodiments of the invention. However, this is non-limiting and it is noted that the exemplary embodiments of the invention can be incorporated using conventional media access control signaling and/or a conventional media access control frame.

In accordance with the exemplary embodiments of the invention, a network node, such as an AP, is enabled to use novel CX-PP-MAC fields incorporated into a MAC frame, such as the PP-MAC frame, to inform the STAs within the frame duration about the occupancy status and location (in terms of frequency or channel width) of other coexisting networks. Novel features in accordance with the embodiments include a method of facilitating coexistence between heterogeneous wireless networks using minimal changes to a MAC protocol frame. Further, in accordance with the exemplary embodiments, an occupancy status could be transmitted for data transmission but also for control packets such as ACK, RTS, CTS packets etc. by modifying a PLCP and/or MAC header.

As stated above, in a non-limiting exemplary embodiment, a probe and pull media access control (PP-MAC) scheme is described in application Ser. No. 13/289,332. The PP-MAC scheme may be used to intersperse and schedule duration of downlink and uplink transmissions for a network device, such as a user device in a WiFi network, as well as prioritize contention periods for user devices based on a quality of service required. The sensor nodes and/or devices may keep their wireless interfaces in a sleeping, inactive, or low-power state until they have data to send, such as sensing information as in accordance with the exemplary embodiments. While the sleeping, inactive, or low-power state may refer to the state of the wireless or radio interfaces, the sleeping, inactive, or low-power state may also refer to a state of other circuitry or modules within the nodes, such as baseband processors which may process, modulate, and/or demodulate data for transmitting and/or receiving by a wireless or radio interface. The devices may, for example, monitor events while maintaining their wireless or radio interfaces in the inactive state. When a sensor node has data to send, the sensor node may transition its wireless interface (or other module) to an active state. Such monitored or recorded data can include at least MAC communications, in accordance with the exemplary embodiments of the invention, as described below. In the active state, the sensor nodes/APs may listen for messages from the access point, which may initiate the sending of the recorded data from the sensor nodes to the access point.

The access point may also have a limited duty cycle, or may continually maintain its wireless interface in an active state. The access point may send PROBE messages to the sensor nodes periodically, and/or non-periodically and/or based on prompts from outside a network, such as outside a wireless network. The PROBE message may identify a group of sensor nodes, or may be broadcast. The sending of the PROBE message that identifies the group of sensor nodes may allow the access point to probe the sensor nodes in the group in parallel to determine at least which sensor nodes have data to transmit and how much data each sensor node needs to transmit.

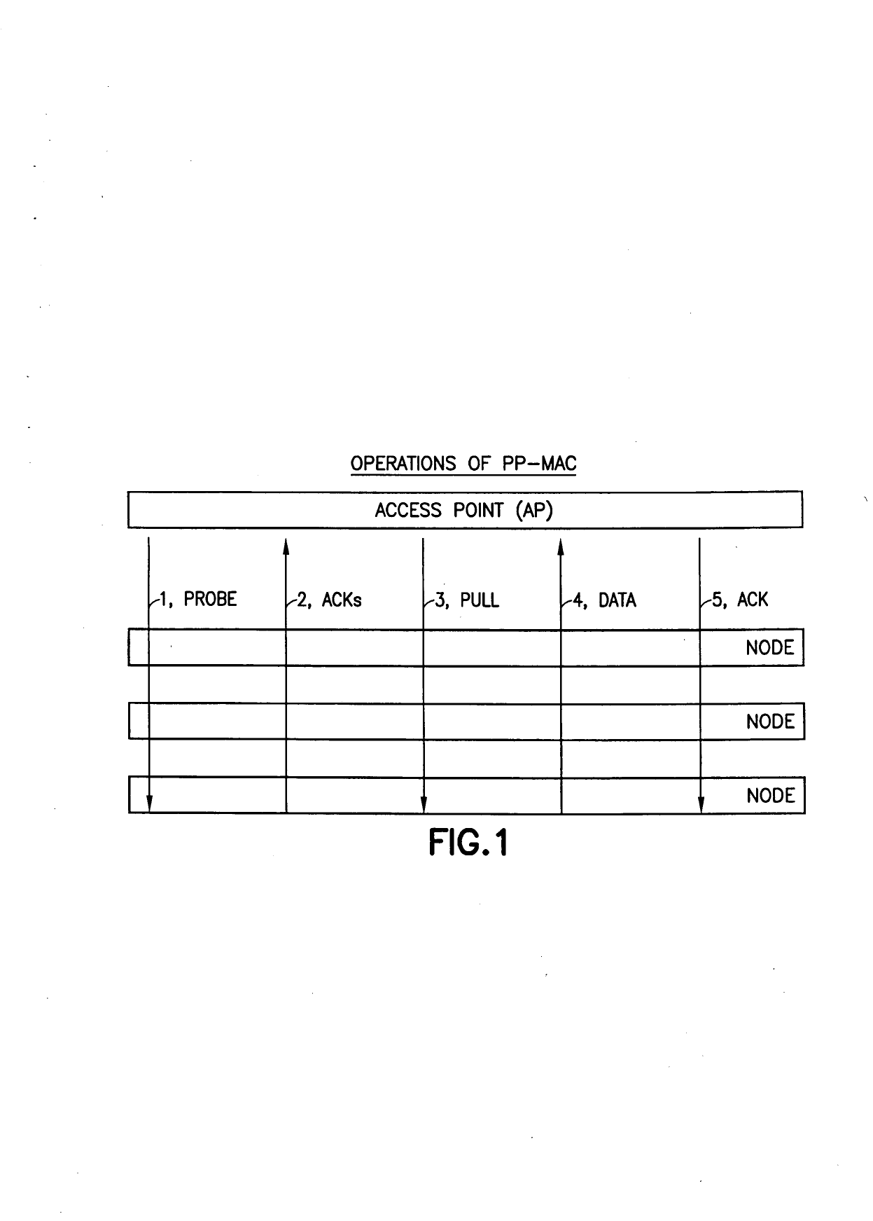

FIG. 1 illustrates an exemplary probe and pull media access control (PP-MAC) sequence implementation between more than one device (i.e., sensor nodes) and an access point (AP) of a wireless communication network. The PP-MAC sequence implementation can be used to enable a device, such as an access point, to receive an ACK from each of the multiple devices of a wireless network and to detect which device each ACK came from. Further, in accordance with the exemplary embodiments of the invention, the PP-MAC sequence can be used to perform the novel sensing and communicating features as at least described below.

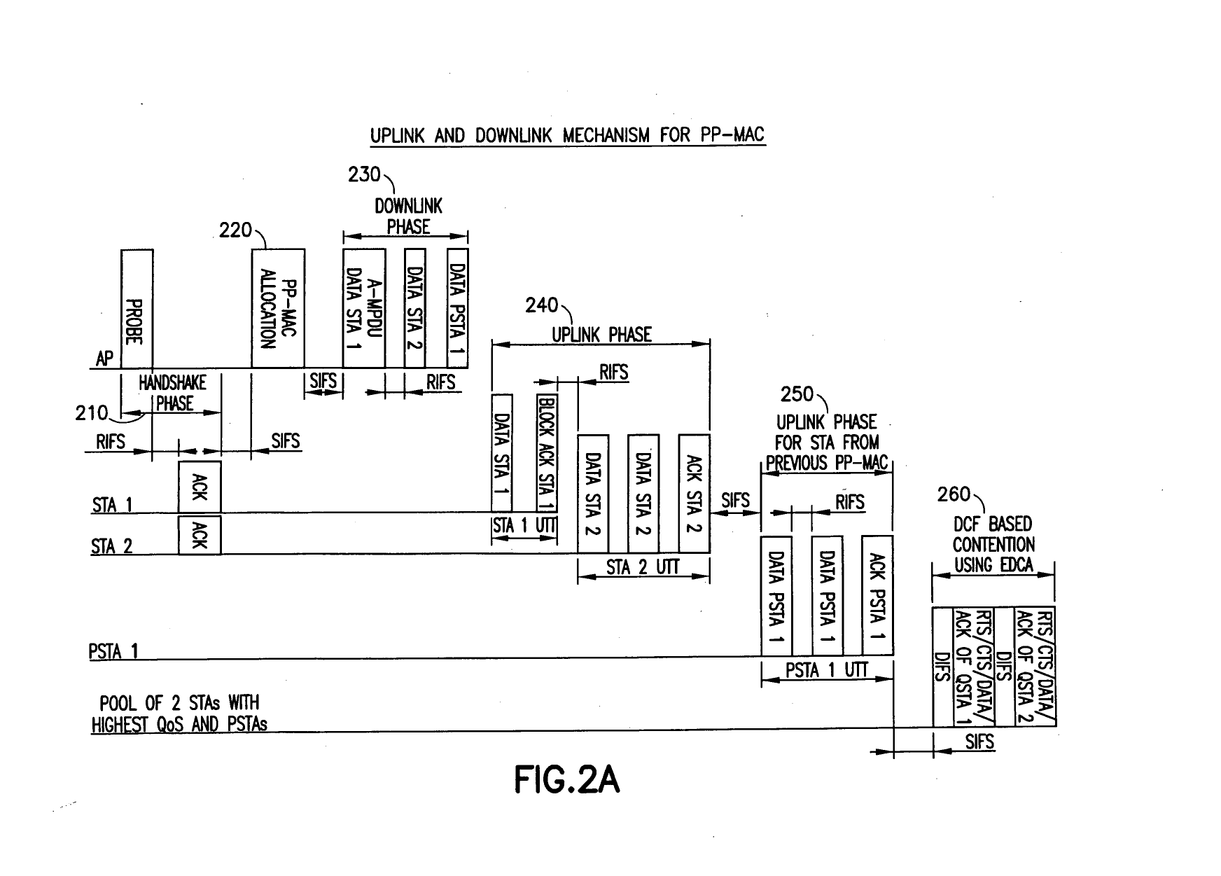

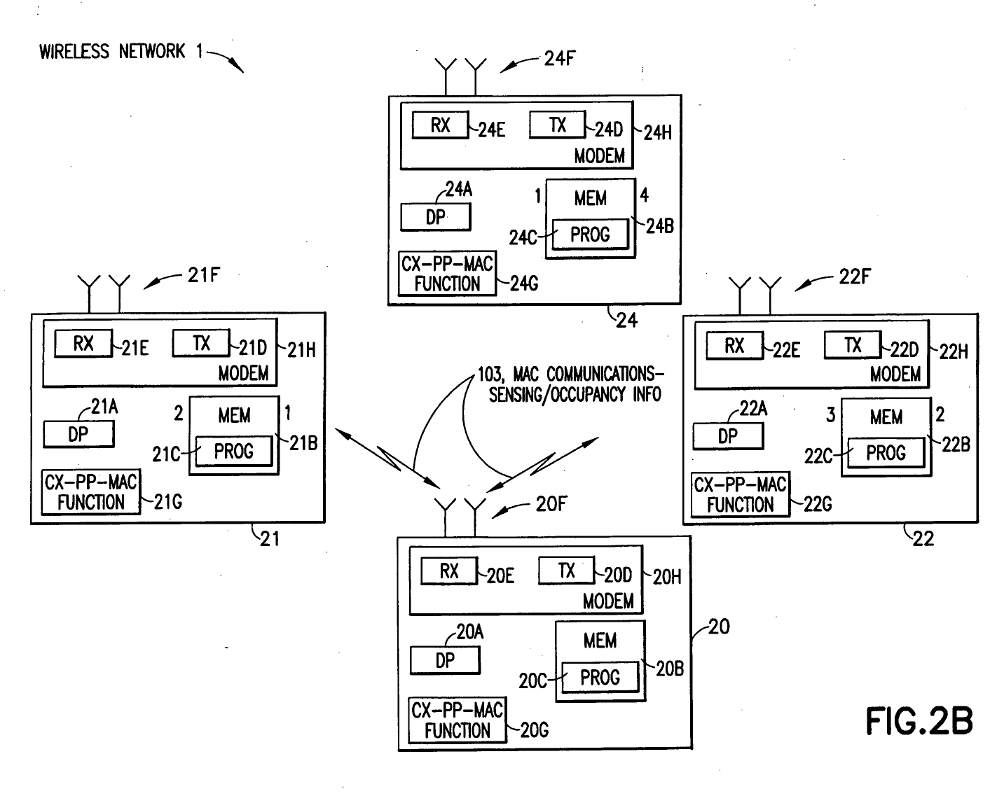

In regards to FIG. 2, there is illustrated Uplink and Downlink Mechanisms for the PP-MAC. The PP-MAC enables uplink and downlink mechanisms which enable operational phases comprising a handshake phase 210, a PP-MAC allocation 220, a downlink phase 230, an uplink phase 240, an uplink phase for STAs from a previous PP-MAC 250 and a contention phase 260.

In accordance with an exemplary embodiment of the invention there is a novel method for using a MAC frame, including a MAC frame used in known or generic signaling, or a PP-MAC Frame to facilitate coexistence of a wireless network with other wireless networks. Any of these other wireless networks can comprise mobile devices, such as STAs in an IEEE 802.11ah network, for example. In accordance with the exemplary embodiments of the invention, a conventional MAC or PP-MAC is modified and/or there is incorporated in the MAC format a CX-PP-MAC frame in order to exchange coexistence information broadcasted or individually sent by the AP to the STAs within the same BSS of a WiFi network.

Further, in accordance with the exemplary embodiments of the invention there is disclosed an incorporated and/or modified MAC frame format to enable the STAs to inform another device, such as an AP, of network coexistence decisions, such as based on sensing. Further, in accordance with the exemplary embodiments, there is an incorporated and/or modified MAC frame format to enable a device, such as an AP, to receive sensing information from the STAs. The sensing information then able to be used by the device/AP to determine occupancy information regarding different coexisting wireless networks.

It is noted that IEEE 802.15.4g based smart utility networks (SUNs) are low rate personal area networks (LR-PANs) that enable multiple applications to operate over shared network resources, providing monitoring and control of a utility system. SUN devices are designed to operate in very large-scale, low power wireless applications and often require using the maximum power available under applicable regulations, in order to provide short range, point-to-point connections. The SUNs operate over multiple spectra ranging from 450-470 MHz, 470-510 MHz, 779-787 MHz, 863-870 MHz, 896-901 MHz, 902-928 MHz, and off course the 2.4 GHz band. Media Access Control (MAC) enhancements are essential for both infrastructure and ad-hoc wireless networks that consist of large numbers of wireless devices (stations/access points). The PP-MAC as described in application Ser. No. 13/289,332 enables energy efficient operations of these devices by supporting radio level duty cycling. The PP-MAC also offers low communication latency with fixed bounds, high throughput, high bandwidth utilization, and quality of service (QOS). The PP-MAC is applicable to the 802.11ah and to wireless networks in general. The PP-MAC protocol supports IEEE 802.11ah requirements:
Sensor nodes/AP with up to 1 km direct wireless communication range (such as outdoor)
Up to 6000 sensor nodes in 1 network
Bounded and low communication latency
Low duty cycles of sensor nodes (<1%)
High data rates
High bandwidth utilization
QOS

As indicated above, there is an overlapping spectrum (902-928 MHz) of operation between the SUN networks and the IEEE 802.11ah-based WiFi networks. The novel CX-PP-MAC is a comprehensive mechanism for the infrastructure-based wireless networks to coexist with other networks, such as short-range SUNS. The overlapping spectrum can result in inadmissible interference when operating concurrently. Devices of the SUN networks operate using a 200 KHz bandwidth while the WiFi networks can operate over a 2, 4, 8, or 16 MHz band. The exemplary embodiments of the invention provide at least a novel coexistence mechanism CX-PP-MAC for the WiFi networks. The CX-PP-MAC can be used to avoid mutual interference as can be caused by a coexisting network, such as a SUN network for example.

In accordance with the exemplary embodiments, there is exchanging information based on a location of null sub-carriers within an overlapping bandwidth between network devices, such as between an AP and STAs associated with the same BSS. Further, in accordance with the embodiments, a network device, such as a STA, based on the received information can avoid operating in overlapping bandwidth. The exemplary embodiments provide a novel method for sharing such coexisting network information in the PP-MAC header (such as by the AP) and a newly defined PLCP header (such as by each STA).

A reference is now made to FIG. 2B for illustrating a simplified block diagram of various electronic devices and apparatus that are suitable for use in practicing the exemplary embodiments of this invention. In FIG. 2B a network node 20 is adapted for communication over a wireless link (not specifically shown) with mobile apparatuses, such as mobile terminals, UEs or user devices 21, 22 and 24. The network node 20 can be a WLAN access point or any WiFi device enabled to operate in accordance with the exemplary embodiments of the invention as described above. The UEs or user devices 21, 22 and 24 can be any device in the wireless network 1 enabled to operate in accordance with the exemplary embodiments of the invention as described above. The network node 20 may be embodied in a network node of a communication network, such as embodied in a base station of a cellular network or another device of the cellular network. In one particular implementation, any of the user devices 21, 22 and 24 may be embodied as a WLAN station STA, either an access point station or a non-access point station, or may be incorporated in a cellular communication device.

The network node 20 includes processing means such as at least one data processor (DP) 20A, storing means such as at least one computer-readable memory (MEM) 20B storing at least one computer program (PROG) 20C, and may also comprise communicating means such as a transmitter TX 20D and a receiver RX 20E for bidirectional wireless communications with the user device 24 via one or more antennas 20F. The RX 20E and the TX 20D are each shown as being embodied with a modem 20H in a radio-frequency front end chip, which is one non-limiting embodiment; the modem 20H may be a physically separate but electrically coupled component. Further, the network node 20 incorporates a CX-PP-MAC function 20G which is coupled to at least the DP 20A, the MEM 20B and the PROG 20C of the network node 20. The CX-PP-MAC function 20G to be used with at least the MEM 20B and DP 20A to transmit the MAC and/or other communications including sensing/occupancy information messaging 103, as in accordance with the exemplary embodiments of the invention as at least described herein.

The user device 21 similarly includes processing means such as at least one data processor (DP) 21A, storing means such as at least one computer-readable memory (MEM) 21B storing at least one computer program (PROG) 21C, and may also comprise communicating means such as a transmitter TX 21D and a receiver RX 21E and a modem 21H for bidirectional wireless communications with other apparatus of FIG. 2B via one or more antennas 21F. Using the CX-PP-MAC function 21G, the user device 21 is at least enabled to perform the exemplary operations including at least processing the MAC and/or other communications including MAC and/or other communications including sensing/occupancy information messaging 103 from the network node 20 and co-existing network signaling operations in accordance with the exemplary embodiments of the invention, as described above, such as from any of the other devices as illustrated in FIG. 2B.

Similarly, the user device 22 includes processing means such as at least one data processor (DP) 22A, storing means such as at least one computer-readable memory (MEM) 22B storing at least one computer program (PROG) 22C, and may also comprise communicating means such as a modem 22H for bidirectional communication with the other devices. Similar to the user device 21 the user device 22 is at least enabled, using the CX-PP-MAC function 22G, to perform the operations including at least processing MAC and/or other communications including sensing/occupancy information messaging 103 from the network node 20 and sensing information signaling operations, in accordance with the exemplary embodiments of the invention.

The user device 24 includes its own processing means such as at least one data processor (DP) 24A, storing means such as at least one computer-readable memory (MEM) 24B storing at least one computer program (PROG) 24C, and may also comprise communicating means such as a transmitter TX 24D and a receiver RX 24E and a modem 24H for bidirectional wireless communications with devices 20, 21, 22 and 24 as detailed above via its antennas 24F. Thus, similar to the user devices 21 and 22 the user device 24 is at least enabled, using the CX-PP-MAC function 24G, to perform the operations including at least processing the MAC and/or other communications including sensing/occupancy information messaging 103 from the network node 20 and sensing information signaling operations, in accordance with the exemplary embodiments of the invention. In addition, while the network node 20 and user devices 21, 22 and 24 are discussed with respect to the network node 20 acting as a centralized node, the disclosure included herein may also apply to mesh networks, in which any node may probe and pull data from other nodes, as can the network node 20.

At least one of the PROGs 20C, 21C, 22C and 24C in the respective network device 20, 21, 22 and 24 is assumed to include program instructions that, when executed by the associated DP 20A, 21A, 22A and 24A enable the respective device to operate in accordance with the exemplary embodiments of this invention, as detailed above. Blocks 20G, 21G, 22G and 24G summarize different results from executing different tangibly stored software to implement certain aspects of these teachings. In these regards the exemplary embodiments of this invention may be implemented at least in part by computer software stored on the MEM 20B, 21B, 22B and 24B which is executable by the DP 20A, 21A, 22A and 24A of the respective other devices 20, 21, 22 and 24 or by hardware, or by a combination of tangibly stored software and hardware (and tangibly stored firmware). Electronic devices implementing these aspects of the invention need not be the entire devices as depicted at FIG. 2B, but exemplary embodiments may be implemented by one or more components of same such as the above described tangibly stored software, hardware, firmware and DP, or a system on a chip SOC or an application specific integrated circuit ASIC.

Various embodiments of the computer readable MEMs 20B, 21B, 22B and 24B include any data storage technology type which is suitable to the local technical environment, including but not limited to semiconductor based memory devices, magnetic memory devices and systems, optical memory devices and systems, fixed memory, removable memory, disc memory, flash memory, DRAM, SRAM, EEPROM and the like. Various embodiments of the DPs 20A, 21A, 22A and 24A include but are not limited to general purpose computers, special purpose computers, microprocessors, digital signal processors (DSPs) and multi-core processors.

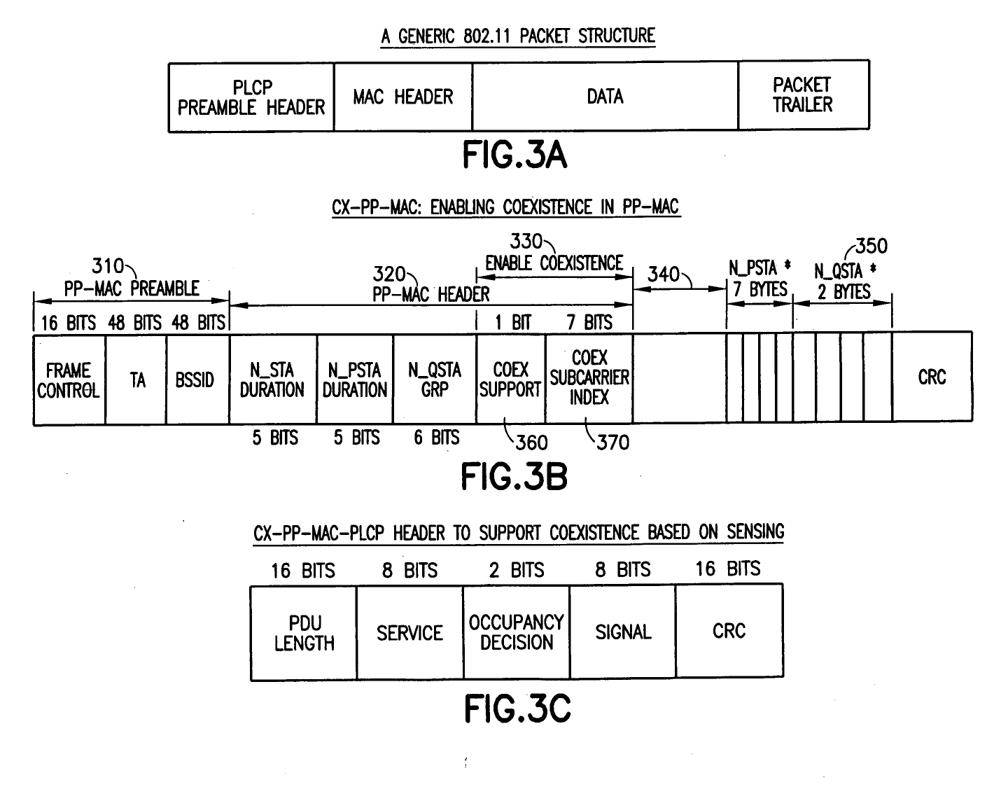

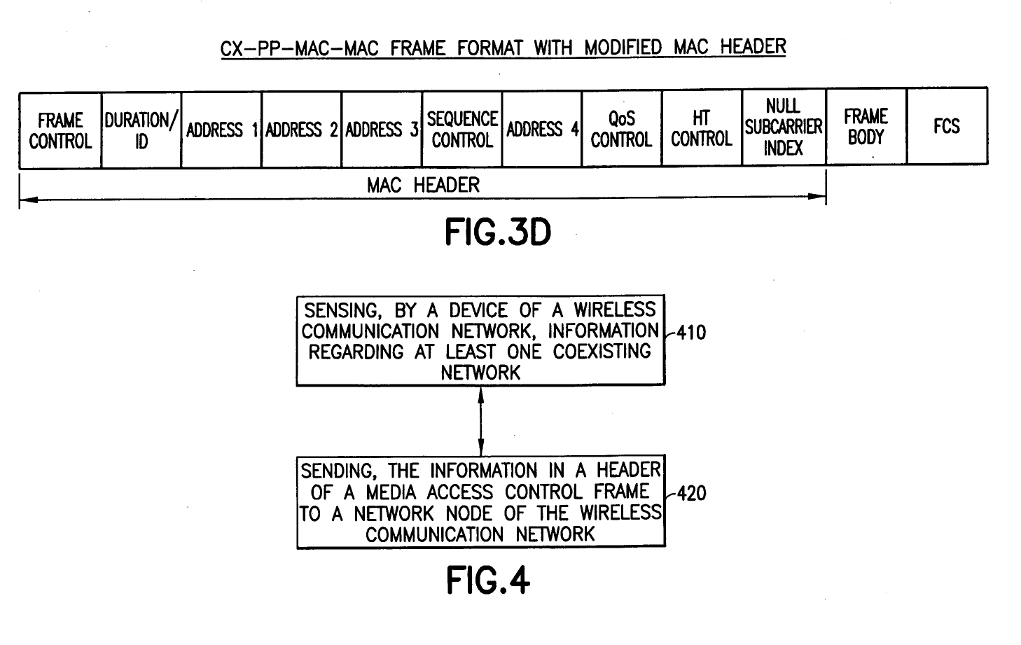

FIG. 3A illustrates an 802.11 Packet Structure. As similarly stated above, the exemplary embodiments of the invention can be performed using any generic packet structure used for communication in a wireless network, such as an 802.11x network. The exemplary embodiments of the invention can be performed using this type of generic packet structure/frame or any type of known or generic packet header, structure, or frame. The embodiments of the invention, as described in this paper, can be incorporated, similarly as at least described below, in at least the PLCP, MAC, and/or Data fields of this or any type of generic 802.11 packet structure.

FIG. 3 B illustrates a CX-PP-MAC in accordance with an exemplary embodiment of the invention. As illustrated in FIG. 3B, the CX-PP-MAC frame includes a PP-MAC preamble 310, PP-MAC header 320, N_STA section 330, N_PSTA section 340, N_QSTA section 350, a Coex support field 360, and a Coex subcarrier index 370.

These fields are used to provide at least information regarding a coexisting network and an overlapping channel width of a coexisting network. In accordance with the exemplary embodiments these fields are used to provide significant advantages at least for interference management in a wireless network. As will be described in more detail below, the Coex Support field, in accordance with the embodiments, provides an indication of whether a coexisting network is using any section of an operating channel of a device, such as an STA. The Coex Subcarrier Index field, in accordance with the embodiments, provides an indication of an overlapping operating channel width of a coexisting network within another channel width, such as the operating channel of a device, such as an STA.

With regards to FIG. 3C, the N_STA Duration (5 bits) field indicates the duration of the downlink phase for the probed STAs. The N_PSTA Duration (5 bits) field indicates the duration of the downlink phase for the PSTAs. These two durations can be adjustable based on traffic requests from STAs and pending requests from PSTAs. The duration for the N-QSTAs can be computed based on the fixed PP-MAC duration and the above two durations. The N_QSTA GRP field (6 bits) indicates the number of QSTAs allocated for the contention period. This number shall facilitate assuming a value for the minimum contention window for the EDCA based contention. The specification of N_STA Duration and N_PSTA Duration fields assist the QSTAs in computing the exact initiation and duration of the contention phase.

CX-PP-MAC Preamble:

The Frame Control field contains control information used for defining type of 802.11 MAC frame and providing information about processing MAC frame. This field specifies about power management, more data either from STA or the AP, more fragments to be transmitted or not, and whether packets transmitted are retransmissions or new packets. The TA field (6 Bytes) provides the MAC address of the probing AP. The BSSID (6 bytes) specifies the ID of the BSS it would like to serve at that instant.

CX-PP-MAC Header:

The N_STA Duration (5 bits) field indicates the duration of the downlink phase for the probed STAs. The N_QSTA Duration (5 bits) field indicates the duration of the downlink phase for the PSTAs. These two durations can be adjustable based on traffic requests from STAs and pending requests from PSTAs. The duration for the N-QSTAs can be computed based on the fixed PP-MAC duration and the above two durations. The N_QSTA GRP field (6 bits) indicates the number of QSTA groups allocated for the contention period. This number restricts the groups participating in the EDCA based contention. The specification of N_STA Duration and N_PSTA Duration fields assist the QSTAs in computing the exact initiation and duration of the contention phase. Instead of N_STA and N_PSTA duration, for example, an N_STA_DL, N_STA_UL, N_PSTA_DL and N_PSTA_UL may be used. Alternatively, the duration of N_STA and N_P_STA may be signaled as one value as a sum or the duration may be computed implicitly from the following allocations. This field may also be missing and the contention start offset and duration for the QSTA may be signaled separately.

PP-MAC Allocation Schedule:

The STA_ID specifies the ID of the allocated STA. The DTT Start Offset field indicates the start of the PPDU that has the downlink data of the STA with corresponding GRP_ID and STA_ID. Note that GRP_ID is not a required field for the allocated STAs of the currently probed group, since the current PP-MAC duration is for that specific group itself. The offset is specified relative to the end of the PP-MAC frame. The DTT Duration field indicates the end of DL data of a STA relative to the start of the PPDU that contains the first frame destined to the STA. If no DTT is scheduled for a STA, but a UTT is scheduled for that STA, then the DTT Duration is set to 0 and the DTT Start Offset is reserved. Similarly, the UTT Start Offset field indicates the start of the uplink transmissions for the STA with corresponding GRP_ID and STA_ID. The first UTT is scheduled to begin after a SIFS interval from the end of the last scheduled DTT. The UTT Duration field indicates the maximum length of the uplink transmission for an STA. All transmissions by the STA within its designated duration shall lie within the indicated UTT Duration. If no UTT is scheduled for a STA, but a DTT is scheduled for that STA, then the UTT Start Offset and UTT Duration fields are both set to 0. The UTT and DTT durations and start offset fields are similarly defined for all other N_STAs and N_PSTAs. The contention start offset and duration for the QSTAs are defined similarly as above for the STAs. Several possibilities can be applied to reduce the signaling overhead. For example, 2 bits can be added to for each allocation to indicate if the STA is scheduled an UTT or DTT. If a STA is not allocated an UTT or DTT the related fields can be skipped. The offset to start the first DTT allocation can be fixed and hence does not have to be signaled. Instead of signaling the offset and duration, only the duration may be signaled. The STA can calculate the offset for the own allocation by summing up the durations of the previously allocated STA and by adding the appropriate spacing between the transmissions as illustrated in FIG. 2 as well as the required time to acknowledge packets.

In accordance with the exemplary embodiments, a CX-PP-MAC header in accordance with the embodiments provides novel features to allow a device, such as an STA, to report information with regards to other coexisting networks. In a non-limiting example the exemplary embodiments enable an STA to relay detected or sensed information related to a coexisting network such as an IEEE 802.15.4g based devices in a coexisting network, such as a SUN network. The CX-PP-MAC resource allocation will support a distributed sensing mechanism in order to allow a device to detect information such as an operating frequency range of a coexisting network. Sensing of coexisting networks will be performed by these devices during their uplink phases. Further, the CX-PP-MAC resource allocation enables the STAs and PSTAs to report sensing information regarding operating channel width(s) of the coexisting network(s) to another network device, such as an AP. In accordance with the exemplary embodiments of the invention, the STAs and the AP are enabled to exchange null sub-carriers equivalent to an operating channel width of 200 KHz for sensed/detected information regarding a coexisting network.

Method I

In accordance with the exemplary embodiments of the invention, the PP-MAC header will have two additional fields as shown in the CX-PP-MAC frame as illustrated in FIG. 3B. The first field is Coex Support field (1 bit) 360. This field provides information to inform the STAs about ongoing transmissions from a coexisting network. This bit is set to 1 if a coexisting network is detected in any section of the operating channel and set to 0 otherwise. The next field is Coex Subcarrier Index 370 (7 bits) for 2 Mhz bandwidth. If the bandwidth increases (e.g., 4 Mhz, 16 Mhz, etc.) and hence there are an increased number of sub-carriers, the number of bits to indicate a number of sub-carrier indices might be more. This field provides the exact overlapping operating channel width of the coexisting network within a wider TREE 802.11ah channel width. The overlapping frequency range is specified in terms of the sub-carrier index (0 to 51). The index implies the sub-carrier index corresponding to a starting frequency of a coexistent network transmission. While in general, any number of sub-carrier indices could be signaled, in the following we restrict the maximum number of sub-carrier indices to 2 in order to reduce the signaling overhead.

In accordance with the exemplary embodiments there is allowed a maximum of two distinct Coex Subcarrier Index fields for cases when, instead of one, two different fractions of operating bandwidth of a coexisting network are detected to be occupied by proximal networks. Allowance of an increasing number of coexisting networks may randomly fragment the operational bandwidth. This in turn, shall result in receiver complexity in order to construct such random non-contiguous OFDM signals. In addition, an increasing number of coexisting networks may result in increased feedback signaling overhead and less bandwidth available for utilization, such as in the overlapping operational bandwidth, as more resources are dedicated to the coexisting networks. Hence, we restrict to protect two coexisting networks. Information about the coexisting network at the AP is a type of feedback from the sensing results obtained from the probed group in the previous PP-MAC duration. The AP makes the final decision on occupancy based on received decisions from STAs and PSTAs. The bit Coex Support is set to 1 if the AP receives decisions on occupancy from more than a certain percentage of STAs and PSTAs. The variable length PP-MAC evolves from the fact when the operating channel is detected to be unoccupied by any coexisting network. If sensed idle, the above mentioned two fields shall not be transmitted at all, implying to the STAs and PSTAs in the current PP-MAC duration that no activity from coexisting networks has been notified in the previous PP-MAC duration. This information will be utilized by the STAs and PSTAs while indicating the sensing decisions back to the AP and will be illustrated below. Based on the received decisions from the probed STAs and PSTAs, upto a maximum of two Coex Subcarrier Index fields can be specified by the AP in the CX-PP-MAC header.

In an alternative exemplary embodiment, a coexistence map may be transmitted for instance, a 2 Mhz bandwidth could be divided into 10 200 Khz subchannels and a 10 bit map is transmitted indicating whether each of the subchannels are occupied or free (e.g. 0 is free 1 is occupied or vice-versa). Hence a bit-map 0000010001 indicates sub-channels 6 and 10 are occupied. In such a case, it might not be necessary to use a separate Coex Support bit as 0000000000 may indicate that no subchannels are occupied and hence, there is no need for coexistence support.

Sensing is conducted by each STA at the beginning of its allocated uplink duration specified by the PP-MAC Allocation frame, prior to any data transmission. Sensing during the contention phase can be performed by QSTAs (STAs in the contention phase)such as using QP-CSMA-CA or any other sensing mechanisms. Alternatively, a dedicated sensing duration may be allocated by the AP for all the probed or allocated STAs before data transmission phase. This duration may be specified in the PP-MAC header. From here, an STA can represent an STA, a PSTA, or a QSTA. The STAs may use energy detection during this period to detect active transmissions from the other coexisting network. The resolution bandwidth may be set to the operating bandwidth of the other network, (e.g., 200 KHz for SUN networks). The sensing bandwidth is set to current operating bandwidth (2 MHz, 4 MHZ, etc.) as specified in 802.11ah Standard. Based on sensing decisions, each STA in its allocated or contentious transmitting slot nulls specific range of sub-carriers in an OFDM symbol that overlap with an existing coexisting network device transmission. As mentioned earlier, the STAs may null a maximum of two sub-carrier sets in order to coexist with two of the most heavily interfered coexisting networks. The location of these range of null sub-carriers need to be informed to the AP. The signaling details about informing the AP are illustrated in details below.

Prior to data transmission after the quiet period, the packets are framed (based on the PLCP header indication) at the STA by nulling sub-carriers at the detected locations in order to avoid interference with other coexisting networks. Now, each STA needs to indicate its sensing decision as well as the location of null sub-carriers.

In an exemplary embodiment, an STA utilizes 2 bits reserved in the existing PLCP header to indicate its sensing decision. The Occupancy Decision (2 bits) field, shown in FIG. 3C, in the PLCP header specifies whether the location(s) specified by the AP in the PP-MAC header (shown in FIG. 3) matches with that of the sensing decision by an STA. The four possibilities of the Occupancy Decision field are as follows:

1. The bit sequence 00 is reserved for the case when a STA intends to inform the AP that it did not detect any coexisting heterogeneous wireless network in any of the two locations specified by the Coex Subcarrier Index field in the PP-MAC header. In such a case, the AP, after decoding these two bits, implies that the corresponding STA did not null any sub-carrier and it had utilized the entire channel for data transmission.

2. The bit sequence 11 is reserved when an STA intends to inform the AP about detection decision at a different location (other than the two mentioned by the Coex Subcarrier Index field in the PP-MAC header) of occupancy by a coexisting network.

3. The remaining two values, i.e., 01 and 10, may indicate if the detection decision by an STA matches with the sub-carrier index or indices defined by the Coex Subcarrier Index field(s) in the PP-MAC header.

Therefore, this proposition abides by the fixed length of the PLCP header by just utilizing the two reserved bits.

If a STA or a PSTA senses a coexisting coexisting network device transmission at a different location, not specified in the Coex Subcarrier Index field by the AP, i.e., the Occupancy Decision field value equal to 11, then it utilizes the MAC frame to inform the AP about the location of null sub-carriers. We propose to introduce a new field termed as Null Subcarrier Index, depicted in FIG. 3D, for indication of locations of null sub-carriers in the MAC header. The Null Subcarrier Index (6 bits) field is to indicate to the AP about the exact location, in terms of the subcarrier index, of the coexisting network device transmission. It is to be noted that for the bit sequences 00, 01, and 10 in the Occupancy Decision field, the STA does not transmit these 6 bits in the Null Subcarrier Index field to 0. Therefore, for bit sequences 00, 01, and 10, the AP may not expect these 6 bits in the MAC header and only expect these 6 bits for a bit sequence 11 in the Occupancy Decision field within the PLCP header.

From above, there can be three possibilities of packet transmission by an STA and decoding at the AP:
(i) For bit sequence 00 in PLCP header: An STA does not null any of the data sub-carriers;
(ii) For bit sequences 01 and 10 in PLCP header: An STA nulls data sub-carriers corresponding the locations indicated by 01 or by 10 that matches with either of the locations indicated by the AP in the Coex Subcarrier Index field; the AP decodes the packet accordingly;
(iii) For bit sequence 11 in PLCP header: An STA transmits initial packet with modified PLCP header and MAC header but does not null sub-carriers in MAC payload. For consecutive packets, the Null Subcarrier Index field provides an indication to the AP about the exact location of null sub-carriers.

In accordance with the exemplary embodiments of the invention, for a bit sequence 11 in the Occupancy Decision field, an STA may send a separate control packet in order to indicate the location of null sub-carriers to the AP. It is noted that in this exemplary embodiment an STA may not modify the MAC frame header as proposed in the previous embodiment. In this situation, a special control packet, termed as sensing decision packet (SDP), is sent when the Occupancy Decision field is set to 11 in the PLCP header of the previous data packet. The SDP may be signaled within the Frame Control field of the existing MAC frame format by using the Type field set to 01 and Subtype field set to 0110. These fields are reserved currently in the present WiFi systems.

In another exemplary embodiment, a fixed larger size PLCP header could be transmitted e.g. in FIG. 3C the occupancy decision could be increased to N bits where N is the number of bits needed to indicate the occupied subcarriers. For example, if there are 52 subcarriers, 6 bits are needed to indicate each subcarrier so a maximum of 2×6=12 bits is used for the occupancy decision if 2 subcarrier locations are to be indicated. It is also possible to optimize the number of bits to indicate 2 locations since each subcarrier index blocks out 200 Khz of bandwidth. The position of the second subcarrier could be an offset relative to the 1^{st} subcarrier also resulting in a reduction in the number of bits needed for the second subcarrier.

As mentioned earlier, an alternative method would transmit an N bit sub-channel occupancy indicator. This is further described in method II below.

Method II

The CX-PP-MAC method allows indication of sub-carrier indices by the STAs when detected to be occupied by other coexisting networks. This method uses the PP-MAC header and the PLCP header in order to facilitate coexistence. A STA frames its payloads based on its sensing decision within its allocated uplink phase. We need to accept here that there is a finite amount of time for processing (nulling sub-carriers) of the payloads based on sensing decisions. In order to avoid this processing time, we also illustrate an alternative method for coexistence.

In the alternative approach, both the AP and the STAs use an occupancy map of other networks. As described earlier, the entire operational bandwidth of an IEEE 802.11ah network is divided into a specified number of fractions, each of equivalent bandwidth for the coexisting network. The AP, within the PP-MAC header, informs the entire occupancy map for the channel bandwidth. For example, with N such fractions, an N-bit occupancy map is defined within the PP-MAC header. As mentioned earlier, the Coex Support bit may or may not be present in such a case. Each bit implies an occupancy or non-occupancy decision at the AP. As in CX-PP-MAC, we can allow only two occupied fractions to be informed to the STAs. Hence, the N-bit map will consist of just two 1's and (N-2) 0's. Based on this received information, the STAs process their MAC frames by accordingly nulling sub-carriers at the designated two locations already defined by the AP. Additionally, the STAs still sense at the beginning of their allocated uplink phase and inform the AP by including this information in the MAC header (or other portion of the MAC).

As can be seen from at least the description above, the exemplary embodiments of the invention can be used to the benefit of any device in a wireless and/or wired and/or combination of wired and wireless communication network. The exemplary embodiments of the invention, such as the PP MAC, provide significant improvements in terms of latency, throughput, bandwidth utilization, power utilization and QOS.

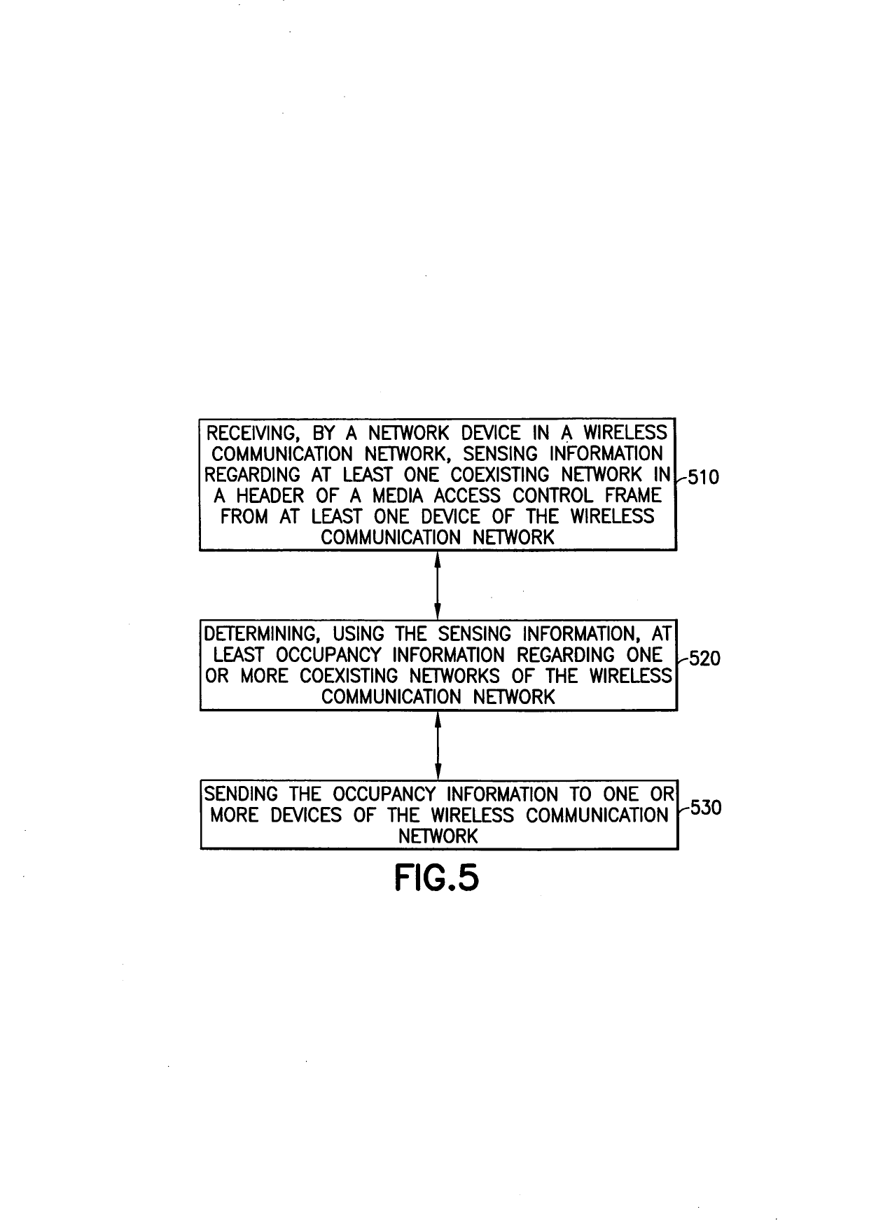

FIGS. 4 and 5 include block diagrams each illustrating a method in accordance with the exemplary embodiments of the invention which may be implemented by any of an apparatus, and executable computer program.

In regards to FIG. 4, at block 410 there is a step of sensing, by a device of a wireless communication network, information regarding at least one coexisting network. Then at block 420 there is a step of sending the information in a header of a media access control frame to a network node of the wireless communication network.

Further, in accordance with the paragraph above, the sending the information includes sending an indication based on the sensing of an occupancy status and an overlapping operating channel width of the at least one coexisting network.

Further, in accordance with the paragraphs above, the information comprises an indication of null sub-carriers based on the occupancy status and the overlapping operating channel width of the at least one coexisting network.

Further, in accordance with the paragraphs above, the sensing is performed based on a media access control message received from the network node, and where the media access control message comprises at least one of an indication of a coexisting network and an overlapping operating channel width of the coexisting network.

Further, in accordance with the paragraphs above, the header is a physical layer convergence protocol header, and where sending the information comprises sending an indication of whether or not the coexisting network indicated by the received media access control message was detected with the sensing.

Further, in accordance with the paragraphs above, the sensing detects a coexisting network other than the coexisting network indicated by the received media access control message, the information further comprising an indication of null sub-carriers based on an overlapping operating channel width of the other coexisting network.

Further, in accordance with the paragraphs above, the indication of the null sub-carriers is using one of a null sub-carrier index field and a bitmap.

In addition, in accordance with the exemplary embodiments of the invention, an apparatus is provided with at least means for sensing, with a device of a wireless communication network, information regarding at least one coexisting network and means for sending the information in a header of a media access control frame to a network node of the wireless communication network.

In accordance with the paragraph above, the means for sensing and the means for sending and the means for receiving comprises an interface to the wireless communication network, and at least one processor and at least one memory including at least one computer program code, the at least one computer program coded executed by at the at least one processor.

Further, in accordance with the exemplary embodiments of the invention, there is at least a method performed with an apparatus comprising sensing, by a device of a wireless communication network, information regarding at least one coexisting network, and sending the information in at least one of a header of a physical layer convergence protocol packet and a header of a media access control frame to a network node of the wireless communication network.

In accordance with the paragraph above, the information is sent in at least one of a control field and a data field in the header of the media access control frame.

Further, in accordance with the paragraphs above, the information comprises at least one of a bit map identifying sub-channels of the overlapping operating channel width as occupied or free and an indication of null sub-carriers using a null sub-carrier index field based on an overlapping operating channel width of the at least one coexisting network.

Turning to FIG. 5, at block 510 there is a step of receiving, by a network device in a wireless communication network, sensing information regarding at least one coexisting network in a media access control frame from at least one device of the wireless communication network. At block 520 there is a step of determining, using the sensing information, at least occupancy information regarding one or more coexisting networks of the wireless communication network. Then as illustrated in block 530 there is a step of sending the occupancy information to one or more devices of the wireless communication network.

Further, in accordance with the paragraph above, the occupancy information is based on an overlapping operating channel width of the at least one coexisting network.

Further, in accordance with the paragraphs above, the determining comprises using the information to null sub-carriers based on at least the overlapping operating channel width of the at least one coexisting network, and where the occupancy information comprises an indication of the null sub-carriers.

Further, in accordance with the paragraphs above, the sensing information is received from more than one device of the wireless communication network, and where the determining comprises determining a minimum amount of null sub-carriers using the sensing information received from the more than one device.

In addition, in accordance with the exemplary embodiments of the invention, an apparatus is provided with at least means for receiving, with a network node in a wireless communication network, sensing information regarding at least one coexisting network in a header of a media access control frame from at least one device of the wireless communication network, means for determining, using at least the sensing information, occupancy information regarding one or more coexisting networks of the wireless communication network, and means for sending the occupancy information to one or more devices of the wireless communication network.

In accordance with the paragraph above, the means for receiving and the means for sending comprises an interface to the wireless communication network, and where the means for determining comprises at least one processor and at least one memory including at least one computer program code, the at least one computer program coded executed by at the at least one processor.

In addition, in accordance with the exemplary embodiments of the invention, there is at least a method performed with an apparatus comprising receiving, by a network node in a wireless communication network, sensing information regarding at least one coexisting network in at least one of a header of a physical layer convergence protocol packet and a header of a media access control frame from at least one device of the wireless communication network, determining, using at least the sensing information, occupancy information regarding one or more coexisting networks of the wireless communication network, and sending the occupancy information to one or more devices of the wireless communication network.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein maybe implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples. Further it is noted that any reference to media access control frame in this paper may be may be alternately referred to as a medium access control frame, or vice versa.

Furthermore, some of the features of the preferred embodiments of this invention could be used to advantage without the corresponding use of other features. As such, the foregoing description should be considered as merely illustrative of the principles of the invention, and not in limitation thereof.

1. A method comprising:
sensing, by a device of a wireless communication network, information regarding at least one coexisting network; and
sending the information in a header of a medium access control frame to a network node of the wireless communication network.

2. The method according to claim 1, where sending the information comprises sending an indication based on the sensing of an occupancy status and an overlapping operating channel width of the at least one coexisting network.

3. The method according to claim 2, where the information comprises an indication of null sub-carriers based on the occupancy status and the overlapping operating channel width of the at least one coexisting network.

4. The method according to claim 1, where the sensing is performed based on a medium access control message received from the network node, and where the medium access control message comprises at least one of an indication of a coexisting network and an overlapping operating channel width of the coexisting network.

5. The method according to claim 4, where the header is a physical layer convergence protocol header, and where sending the information comprises sending an indication of whether or not the coexisting network indicated by the received medium access control message was detected with the sensing.

6. The method according to claim 4, where the sensing detects a coexisting network other than the coexisting network indicated by the received medium access control message, the information further comprising an indication of null sub-carriers based on an overlapping operating channel width of the other coexisting network.

7. The method according to claim 6, where the indication of the null sub-carriers is using one of a null sub-carrier index field and a bitmap.

8. A computer readable memory embodying at least one computer program, the at least one computer program executed by at least one processor to perform the method according to claim 1.

9. An apparatus, comprising:
at least one processor; and
at least one memory including computer program code, where the at least one memory and the computer program code are configured, with the at least one processor, to cause the apparatus to at least:
sense, with a device of a wireless communication network, information regarding at least one coexisting network; and
send the information in a header of a medium access control frame to a network node of the wireless communication network.

10. The apparatus according to claim 9, where sending the information comprises the at least one memory including the computer program code is configured, with the at least one processor, to cause the apparatus to send an indication based on the sensing of an occupancy status and an overlapping operating channel width of the at least one coexisting network.

11. The apparatus according to claim 10, where the information comprises an indication of null sub-carriers based on the occupancy status and the overlapping operating channel width of the at least one coexisting network.

12. The apparatus according to claim 9, where the sensing is performed based on a medium access control message received from the network node, and where the medium access control message comprises at least one of an indication of a coexisting network and an overlapping operating channel width of the coexisting network.

13. The apparatus according to claim 12, where the header is a physical layer convergence protocol header, and where sending the information comprises the at least one memory including the computer program code is configured, with the at least one processor, to cause the apparatus to send an indication of whether or not the coexisting network indicated by the received medium access control message was detected with the sensing.

14. The apparatus according to claim 12, where the sensing detects a coexisting network other than the coexisting network indicated by the received medium access control message, the information further comprising an indication of null sub-carriers based on an overlapping operating channel width of the other coexisting network.

15. The apparatus according to claim 14, where the indication of the null sub-carriers is using one of a null sub-carrier index field and a bitmap.

16.-17. (canceled)

18. A method comprising:
receiving, by a network node in a wireless communication network, sensing information regarding at least one coexisting network in a header of a medium access control frame from at least one device of the wireless communication network;
determining, using at least the sensing information, occupancy information regarding one or more coexisting networks of the wireless communication network; and
sending the occupancy information to one or more devices of the wireless communication network.

19. The method according to claim 18, where the occupancy information is based on an overlapping operating channel width of the at least one coexisting network.

20. The method according to claim 19, where the determining comprises using the information to null sub-carriers based on at least the overlapping operating channel width of the at least one coexisting network, and where the occupancy information comprises an indication of the null sub-carriers.

21. The method according to claim 18, where the sensing information is received from more than one device of the wireless communication network, and where the determining comprises determining a minimum amount of null sub-carriers using the sensing information received from the more than one device.

22. A computer readable memory embodying at least one computer program, the at least one computer program executed by at least one processor to perform the method according to claim 18.

23. An apparatus, comprising:
at least one processor; and
at least one memory including computer program code, where the at least one memory and the computer program code are configured, with the at least one processor, to cause the apparatus to at least:
receive, with a network node in a wireless communication network, sensing information regarding at least one coexisting network in a header of a medium access control frame from at least one device of the wireless communication network;
determine, using at least the sensing information, occupancy information regarding one or more coexisting networks of the wireless communication network; and
send the occupancy information to one or more devices of the wireless communication network.

24. The apparatus according to claim 23, where the occupancy information is based on an overlapping operating channel width of the at least one coexisting network.

25. The apparatus according to claim 23, where the determining comprises the at least one memory including the computer program code is configured, with the at least one processor, to cause the apparatus to use the information to null sub-carriers based at least one the overlapping operating channel width of the at least one coexisting network, and where the occupancy information comprises an indication of the null sub-carriers.

26. The apparatus according to claim 23, where the sensing information is received from more than one device of the wireless communication network, and where the determining comprises determining a minimum amount of null sub-carriers using the sensing information received from the more than one device.

27.-28. (canceled)
